(19) United States
(12) Patent Application Publication
(10) Pub. No.: US 2025/0181016 A1
(43) Pub. Date: Jun. 5, 2025

(54) IMAGE FORMING APPARATUS

(71) Applicant: CANON KABUSHIKI KAISHA, Tokyo (JP)

(72) Inventors: YUTO ASO, Chiba (JP); MASASHI WAKISAKA, Saitama (JP)

(21) Appl. No.: 18/963,159

(22) Filed: Nov. 27, 2024

(30) Foreign Application Priority Data
Dec. 5, 2023 (JP) 2023-205722
Sep. 24, 2024 (JP) 2024-165239

(51) Int. Cl. G03G 15/00; G03G 15/08; G03G 21/00; G03G 21/10

(52) U.S. Cl. CPC G03G 15/5008; G03G 15/0812; G03G 15/757; G03G 21/0011; G03G 21/0064; G03G 21/10

(57) ABSTRACT

An image forming apparatus includes a controller performing a mode for controlling a driving unit to rotate and drive a photosensitive body in a second rotation direction opposite to a first rotation direction, during non-development operation, a sheet provided in contact with the photosensitive body at a position on a downstream of a position where a cleaning member is in contact with the photosensitive body and on an upstream of a development position in the first rotation direction, and a collection portion provided to face the photosensitive body in a non-contact manner in a region below a contact position where the sheet is in contact with the photosensitive body in a gravity direction and between the contact position and an arrival position when the photosensitive body is rotated and driven in the second rotation direction with the contact position as a starting point in the mode in a horizontal direction.

### BACKGROUND

### Field

The present disclosure relates to an image forming apparatus including a developing device that develops an electrostatic latent image formed on an image bearing member, with developer containing toner and carriers.

### Description of the Related Art

An image forming apparatus using an electrophotographic system or the like develops an electrostatic latent image formed on a photosensitive drum (image bearing member) as a toner image by a developing device. Such a developing device, a developing device using a two-component developer containing toner and carriers has been used.

The developing device includes a developing container housing the developer containing the toner and the carriers, a rotatable developing sleeve (rotatable developing member) bearing the developer in order to develop the electrostatic latent image formed on the photosensitive drum, and a developer regulation member regulating an amount of developer born by the developing sleeve.

The developer conveyed by the developing sleeve to a development position (development region) where the electrostatic latent image is developed is magnetically raised in the development region, and a magnetic brush is formed. When the toner in the developer supplied from the magnetic brush in the development region is supplied to the electrostatic latent image, the electrostatic latent image is developed as the toner image. On the other hand, part of the toner in the developer supplied from the magnetic brush in the development region may scatter from the development region without adhering to the electrostatic latent image in the development region. Therefore, in particular in a space below the development region in a gravity direction, an amount of toner floating in the space due to own weight of the toner scattering from the development region is likely to be relatively increased.

A developing device discussed in U.S. Patent Publication No. 20190171130 includes the developer regulation member, a sheet member that abuts on the photosensitive drum and collects the toner scattering downward from the development region in the gravity direction, and a sheet supporting member supporting the sheet member. Therefore, a space below the development region in the gravity direction is formed as a closed space, and the toner scattering from the development region without adhering to the electrostatic latent image in the development region is collected.

The photosensitive drum transfers the toner image adhering to the electrostatic latent image, to an intermediate transfer belt. Transfer residual toner not transferred to the intermediate transfer belt is scraped off by a cleaning blade pressed against the photosensitive drum. The cleaning blade is disposed such that a front-side edge abuts on the photosensitive drum with predetermined pressing force in a direction counter to a normal rotation direction of the photosensitive drum during image formation.

The front-side edge of the cleaning blade abuts on the photosensitive drum in the direction counter to the normal rotation direction of the photosensitive drum with abutting pressure to the photosensitive drum. Therefore, the front-side edge of the cleaning blade comes into tight contact with the photosensitive drum while being distorted due to dragging by the photosensitive drum. Before the front-side edge of the cleaning blade, the toner is dammed by the cleaning blade and is accumulated. When rotation of the photosensitive drum 1 is stopped while the toner is accumulated, the toner is aggregated and fixed to a surface of the photosensitive drum. As a result, at start of normal rotation of the photosensitive drum, the aggregated toner may slip through the front-side edge of the cleaning blade.

An image forming apparatus discussed in U.S. Patent Publication No. 20190278201 performs a refresh mode for rotating the photosensitive drum in a direction opposite to a direction during the image formation. As a result, variation of an amount of abrasive (external additive mixed to toner) at an edge portion of the cleaning blade is suppressed, and the toner is prevented from being aggregated at an abutting portion of the cleaning blade and the photosensitive drum.

On the other hand, in the case of the configuration discussed in U.S. Patent Publication No. 20190171130, the sheet member provided in the developing device abuts on the photosensitive drum. Therefore, the fine external additive contained in the toner slipping through the cleaning blade may adhere to the sheet member. The adhering external additive is interposed between the sheet member and the surface of the photosensitive drum. Therefore, in the case of the configuration discussed in U.S. Patent Publication No. 20190171130, when the photosensitive drum is reversely rotated in the cleaning mode, the external additive may fall down in the gravity direction, and block an optical path of an exposure member exposing the photosensitive drum.

### SUMMARY

The present disclosure is directed to a technique for preventing an external additive interposed between a sheet provided in contact with a photosensitive body and the photosensitive body, from blocking an optical path of an exposure device when the photosensitive body is reversely rotated.

According to some embodiments, an image forming apparatus includes a rotatable photosensitive body, an exposure device configured to expose the photosensitive body to form an electrostatic latent image on the photosensitive body, a developing device including a developing container configured to house a developer containing toner and carriers, and a developer bearing member configured to bear and convey the developer to a development position where the electrostatic latent image formed on the photosensitive body by the exposure device is developed, a cleaning member provided in contact with the photosensitive body and configured to clean the photosensitive body, a driving unit configured to rotate and drive the photosensitive body in a first rotation direction during development operation in which the developing device develops the electrostatic latent image formed on the photosensitive body, a control unit configured to perform a mode for controlling the driving unit to rotate and drive the photosensitive body in a second rotation direction opposite to the first rotation direction, during non-development operation in which the development operation is not performed, a sheet provided in contact with the photosensitive body at a position on a downstream of a position where the cleaning member is in contact with the photosensitive body and on an upstream of the development position in the first rotation direction, and a collection portion provided to face the photosensitive body in a non-contact manner in a region below a contact position where the sheet is in contact with the photosensitive body in a gravity direction and between the contact position and an arrival position when the photosensitive body is rotated and driven in the second rotation direction with the contact position as a starting point in the mode in a horizontal direction.

According to another aspect of the present disclosure, an image forming apparatus includes a rotatable photosensitive body, an exposure device configured to expose the photosensitive body to form an electrostatic latent image on the photosensitive body, a developing device including a developing container configured to house a developer containing toner and carriers, and a developer bearing member configured to bear and convey the developer to a development position where the electrostatic latent image formed on the photosensitive body by the exposure device is developed, a cleaning member provided in contact with the photosensitive body and configured to clean the photosensitive body, a driving unit configured to rotate and drive the photosensitive body in a first rotation direction during development operation in which the developing device develops the electrostatic latent image formed on the photosensitive body, a control unit configured to perform a mode for controlling the driving unit to perform a set of rotating and driving the photosensitive body in a second rotation direction opposite to the first rotation direction and then rotating and driving the photosensitive body in the first rotation direction a plurality of times during non-development operation in which the development operation is not performed, a sheet provided in contact with the photosensitive body at a position on a downstream of a position where the cleaning member is in contact with the photosensitive body and on an upstream of the development position in the first rotation direction, and a collection portion provided to face the photosensitive body in a non-contact manner in a region below a contact position where the sheet is in contact with the photosensitive body in a gravity direction and between the contact position and an arrival position on most downstream of the contact position in the second rotation direction when the photosensitive body is rotated and driven in the second rotation direction with the contact position as a starting point in the mode in a horizontal direction.

Further features of the present disclosure will become apparent from the following description of exemplary embodiments with reference to the attached drawings.

### BRIEF DESCRIPTION OF THE DRAWINGS

FIG. 1 is a cross-sectional view illustrating a configuration of an image forming apparatus according to a first exemplary embodiment.

FIG. 2 is a cross-sectional view illustrating a configuration of a developing device according to the first exemplary embodiment.

FIG. 3 is a cross-sectional view illustrating a configuration of a drum cartridge according to the first exemplary embodiment.

FIG. 4 is a cross-sectional view illustrating arrangement of sheet members provided in the developing device according to the first exemplary embodiment.

FIGS. 5A to 5D are enlarged schematic diagrams illustrating a front-side edge of a cleaning blade when a photosensitive drum is normally rotated.

FIGS. 6A to 6D are enlarged schematic diagrams illustrating the front-side edge of the cleaning blade when the photosensitive drum is reversely rotated.

FIGS. 7A and 7B are outline diagrams illustrating behavior of an external additive on the sheet members when the photosensitive drum is reversely rotated.

FIG. 8 is an outline diagram illustrating leading edge positions of the sheet members provided in the developing device according to the first exemplary embodiment.

FIG. 9 is a diagram illustrating a sequence relating to driving and stopping of the photosensitive drum in a cleaning mode.

### DESCRIPTION OF THE EMBODIMENTS

Various exemplary embodiments, features, and aspects of the present disclosure are described in detail below with reference to accompanying drawings. The following exemplary embodiments do not limit the present disclosure according to the claims. All of combinations of features described in a first exemplary embodiment are not necessarily essential for solving means of the present disclosure. The exemplary embodiments can be implemented in various applications, for example, a printer, various kinds of printing machines, a copier, a facsimile (FAX), and a multifunctional peripheral.

### (Configuration of Image Forming Apparatus)

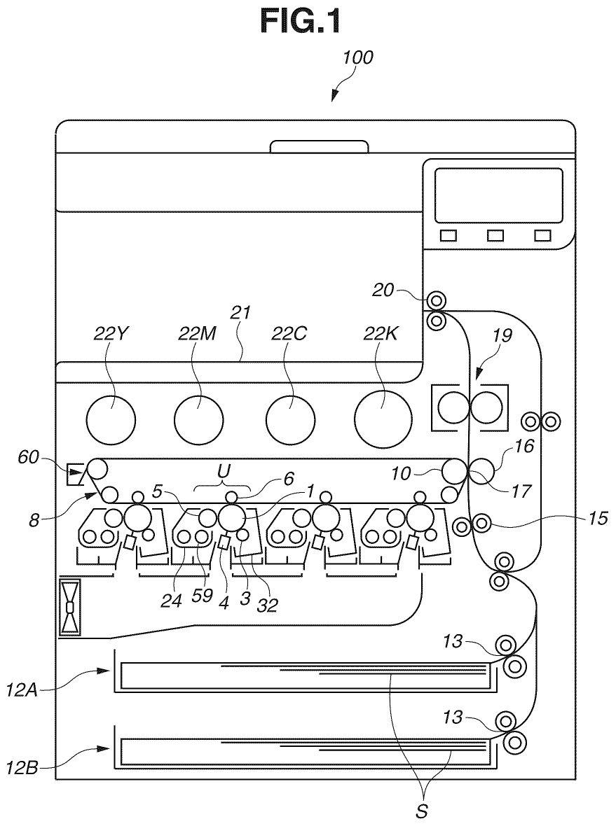

FIG. 1 is a cross-sectional view of an image forming apparatus 100 according to the first exemplary embodiment as viewed from a front side.

The image forming apparatus 100 is a four-color based full-color printer of a tandem intermediate transfer type using an electrophotographic process, and forms a toner image on a sheet S based on image information input to a control circuit unit from an external host apparatus such as a personal computer.

In the cross-sectional view of FIG. 1, the image forming apparatus 100 includes image forming units that sequentially form toner images of four colors of yellow (Y), magenta (M), cyan (C), and black (K), at a substantially center part.

The image forming units forming the toner images of the respective colors have a substantially common configuration. To avoid complication of the drawings, the image forming unit of magenta is denoted by a reference sign U as a representative, and reference signs for the other image forming units are omitted.

Each of the four image forming units U includes a drum cartridge 32 as a photosensitive unit that includes an electrophotographic photosensitive body (hereinafter, referred to as photosensitive drum 1 (1Y, 1M, 1C, or 1K)) having a rotary drum shape as an image bearing member. In the present exemplary embodiment, the photosensitive drum 1 (1Y, 1M, 1C, or 1K) is a cylindrical metal tube having a diameter of 30 mm. In the present exemplary embodiment, a process speed that is a rotation speed of the photosensitive drum 1 (1Y, 1M, 1C, or 1K) is 264 mm/sec (millimeter per second). Each of the four image forming units U further includes a developing cartridge (hereinafter, referred to as developing device 24) as a developing unit including a rotatable developing sleeve 5 (rotatable developing member) developing the toner image. As described above, each of the four image forming units U includes the two units (drum cartridge 32 as photosensitive unit and developing device 24 as developing unit) that are replaceable and detachable.

The drum cartridge 32 includes the rotatable photosensitive drum 1, a charging roller 3 charging the photosensitive drum 1, and a cleaning blade (cleaning member) coming into contact with the photosensitive drum 1 in order to clean a surface of the photosensitive drum 1.

The developing device 24 includes, in addition to the developing sleeve 5, a second conveyance screw 59 that supplies toner to the developing sleeve 5 and stirs the toner.

An exposure device 4 that includes a light emitting element (light-emitting diode (LED)) and an irradiation unit (not illustrated) performing irradiation with light emitted from the light emitting element is disposed between the drum cartridge 32 and the developing device 24.

An intermediate transfer belt 8 as an intermediate transfer member is disposed above the four image forming units U. A sheet cassette 12 is disposed below the four image forming units U. The sheet cassette 12 includes a cassette 12A disposed on an upper part and a cassette 12B disposed on a lower part. The intermediate transfer belt 8 is provided with four primary transfer rollers 6 facing the photosensitive drums 1 of the respective colors.

Further, toner bottles 22Y, 22M, 22C, and 22K are disposed above the intermediate transfer belt 8. The toner bottles are detachable and replaceable, and house replenishing toner for the four image forming units U. Therefore, an appropriate amount of toner is timely replenished from the corresponding toner bottle to the developing sleeve 5 included in each of the four image forming units U, by a toner replenishing mechanism.

### (Image Forming Process)

In an image forming process, it is necessary to form a latent image on the photosensitive drum 1 of each of the four image forming units U. As preparation operation, a high voltage is applied to the charging roller 3 in pressure contact with the photosensitive drum 1, to uniformly charge the surface of the photosensitive drum 1 with rotation of the photosensitive drum 1.

Thereafter, a high voltage is applied to the developing sleeve 5 by a path different from a path of the charging roller 3, to uniformly coat a surface of the developing sleeve 5 with the charge toner inside the developing device 24. At this time, the toner is circulated and conveyed at high speed by the second conveyance screw 59 inside the developing device 24. A rotation speed of the second conveyance screw 59 is relatively extremely higher than the rotation speeds of the developing sleeve 5 and the photosensitive drum 1, which makes it possible to uniformly coat the developing sleeve 5 with the toner without unevenness.

By light emission and light irradiation by the exposure device 4 disposed between the drum cartridge 32 and the developing device 24, an electrostatic latent image caused by potential variation on the surface of the photosensitive drum 1 is formed. When a high voltage is applied to the developing sleeve 5 to generate a potential difference between the developing sleeve 5 and the photosensitive drum 1, the latent image on the photosensitive drum 1 is developed as a toner image with the toner on the developing sleeve 5.

The toner image on the photosensitive drum 1 is primarily transferred to a surface of the intermediate transfer belt 8 in order of the above-described colors, with rotation of the intermediate transfer belt 8. As a result, a superimposed toner image of the four colors Y, M, C, and K is formed on the intermediate transfer belt 8.

A sheet conveyance path conveying the sheet S from a lower part to an upper part is provided on a right side inside a main body of the image forming apparatus 100. A feeding roller pair 13, a registration roller pair 15, a secondary transfer roller 16, a fixing device 19, and a discharge roller pair 20 are disposed in order from the lower side to the upper side of the conveyance path. The secondary transfer roller 16 abuts on a belt driving roller 10 on a right side of the intermediate transfer belt 8 with predetermined pressing force through the intermediate transfer belt 8, thereby forming a secondary transfer nip portion 17 with the intermediate transfer belt 8.

The feeding roller pair 13 is driven at a predetermined control timing, and the sheet (recording medium) S is separated and fed one by one from the sheet cassette 12 and introduced to the sheet conveyance path. The sheet S is introduced to the secondary transfer nip portion 17 by the registration roller pair 15 at a predetermined control timing, and is held and conveyed. As a result, at the secondary transfer nip portion 17, the four-color superimposed toner image on the intermediate transfer belt 8 is secondarily transferred to the sheet S, and an unfixed toner image is formed on the sheet S. The remaining toner not secondarily transferred from the intermediate transfer belt 8 to the sheet S is scraped off by an intermediate transfer belt cleaning blade 60 abutting on the intermediate transfer belt 8. The intermediate transfer belt cleaning blade 60 functions as a cleaning member for cleaning the surface of the intermediate transfer belt 8.

The sheet S delivered from the secondary transfer nip portion 17 is introduced into the fixing device 19, and is subjected to toner image fixing treatment with heat and pressure. The sheet S delivered from the fixing device 19 is discharged as an image-formed matter to a discharge tray 21 disposed above the toner bottles 22 by the discharge roller pair 20.

### (Configuration of Developing Device)

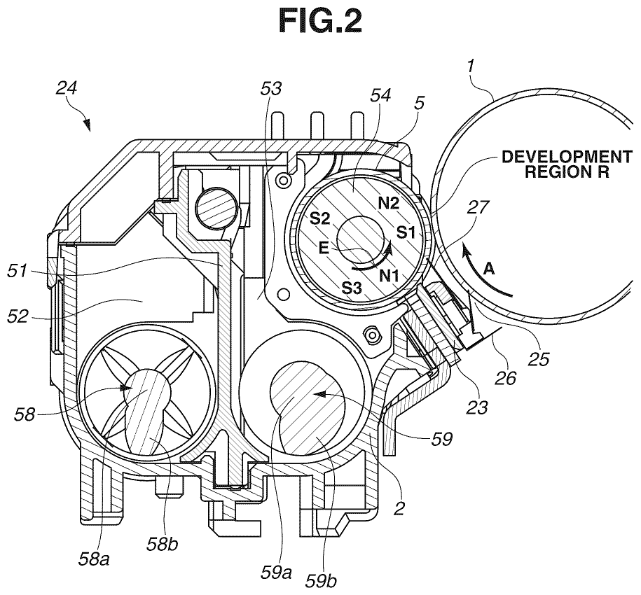

Next, a detailed configuration of the developing device 24 is described with reference to a cross-sectional view in FIG. 2.

The developing device 24 includes a developing container 2 that houses a developer (two-component developer) containing magnetic carriers and non-magnetic toner. A weight ratio of the non-magnetic toner in the two-component developer, namely, toner concentration is about 10 wt % (weight percentage). The radio is appropriately adjusted depending on a charge amount of toner, a carrier particle diameter, a configuration and a use state of the image forming apparatus, or the like, and is not limited to the value.

As the magnetic carriers, for example, metals such as surface-oxidized or non-oxidized iron, nickel, cobalt, manganese, chromium, and rare earth metals, alloys thereof, or ferrite oxides are suitably usable, and a method of manufacturing such magnetic particles is not particularly limited. As the magnetic carriers according to the present exemplary embodiment, carriers obtained by coating ferrite particles with a silicone resin are used. The magnetic carriers have saturation mass magnetization of 294 Am²/kg (ampere×square meter per kilogram) under an applied magnetic field of 240 kA/m (kiloampere per meter), and have specific resistance of 1×10⁷⁻⁸ Ω·cm (ohm×centimeter) at an electric field intensity of 3000 V/cm. In addition, as the magnetic carriers, resin magnetic carriers manufactured by a polymerization method using a binder resin, a magnetic metal oxide, and a non-magnetic metal oxide as starting materials may be used.

A volume average particle diameter of the magnetic carriers is measured using a laser-diffraction grain size distribution measuring device HELOS (manufactured by JEOL Ltd.) in such a manner that a particle diameter range of 0.5 μm to 350 μm is logarithmically divided into 32 channels on a volume basis. The number of particles in each channel is measured. From a measurement result, a median diameter of volume 50% is defined as the volume average particle diameter. In the present exemplary embodiment, the volume average particle diameter of the magnetic carriers is 50 μm (micrometer).

The non-magnetic toner contains at least a binder, a colorant, and a charge control agent. In the present exemplary embodiment, a styrene acrylic resin is used as a binder resin, but a resin such as a styrene resin, a polyester resin, or a polyethylene resin can be used. As the colorant, phthalocyanine blue is used in the present exemplary embodiment, but various pigments or various kinds of dyes such as carbon black, chrome yellow, Hansa yellow, benzidine yellow, threne yellow, quinolone yellow, permanent orange GTR, pyrazolone orange, vulcan orange, watch young red, permanent red, brilliant carmine 3B, brilliant carmine 6B, Du Pont oil red, pyrazolone red, lithol red, rhodamine B lake, lake red C, rose Bengal, aniline blue, ultramarine blue, chalco oil blue, methylene blue chloride, phthalocyanine green, and malachite green oxalate may be used alone as the colorant, or a plurality of types of colorants may be used together.

The charge control agent may contain a charge control agent for reinforcement as desired. All known agents can be used as the charge control agent for reinforcement. Examples of the charge control agent include a nigrosine dye, a triphenylmethane dye, a chromium-containing metal complex dye, a molybdic acid chelate pigment, a rhodamine dye, alkoxy amine, a quaternary ammonium salt (including fluorine-modified quaternary ammonium salt), alkylamide, a simple substance or compound of phosphorous, a simple substance or compound of tungsten, a fluorine activator, a salicylic acid metal salt, and a salicylic acid derivative metal salt.

The non-magnetic toner may contain wax or an external additive. The wax is contained to improve release property from the fixing member and fixability in fixing. As the wax, paraffin wax, carnauba wax, polyolefin, or the like can be used, and the wax is kneaded and dispersed in the binder resin for use. In the present exemplary embodiment, a resin in which the binder, the colorant, the charge control agent, and the wax are kneaded and dispersed, pulverized by a mechanical pulverizer is used.

Examples of external additive particles include particulates obtained by performing hydrophobic treatment on amorphous silica, and inorganic oxide particulates of titanium oxide, titanium compound, and the like. By externally adding the particulates to a toner base, powder flowability and a charging amount of toner are suitably controlled. The diameter of the external additive particles is desirably about 1 nm to about 100 nm. In the present exemplary embodiment, titanium oxide having an average particle diameter of 50 nm is externally added at a weight ratio of 0.5 wt %, and amorphous silica having an average particle diameter of 2 nm and 100 nm is externally added at weight ratios of 0.5 wt % and 1.0 wt %.

The developing device 24 includes the developing sleeve 5 as a developer bearing member that bears and conveys the developer in the developing container 2. A surface of the developing sleeve 5 is rotatably held, and a magnet roller 54 including a plurality of magnetic poles (scooping pole S3, regulating pole N1, developing pole S1, conveying pole N2, and peeling pole S2) is unrotatably disposed inside the developing sleeve 5. In the present exemplary embodiment, an outer diameter of the developing sleeve 5 is 18 mm.

The developing container 2 is partitioned into a first conveyance path (stirring chamber) 52 as a first chamber and a second conveyance path (developing chamber) 53 as a second chamber by a partition 51. The first conveyance path 52 and the second conveyance path 53 communicate with each other through communication ports at both ends. Therefore, the first conveyance path 52 and the second conveyance path 53 form a circulation path for the developer.

The developing container 2 is provided with two screw members as conveyance members that convey the developer while stirring the developer. More specifically, a first conveyance screw 58 is provided in the first conveyance path 52, and a second conveyance screw (second conveyance unit) 59 is provided in the second conveyance path 53. The first conveyance screw 58 includes a rotary shaft 58a, and a blade 58b provided in a spiral shape around the rotary shaft 58a (on rotation axis). The second conveyance screw 59 includes a rotary shaft 59a and a blade 59b provided in a spiral shape around the rotary shaft 59a (on rotation axis). The second conveyance screw 59 is a screw that stirs the developer and supplies the developer to the developing sleeve 5.

When the first conveyance screw 58 is rotated around the rotary shaft 58a, the blade 58b in a spiral shape conveys the developer in a first direction toward one side in a longitudinal direction of the developing device 24 (axial direction of rotary shaft 58b) inside the first conveyance path 52. When the second conveyance screw 59 is rotated around the rotary shaft 59a, the blade 59b in the spiral shape conveys the developer in a second direction (direction opposite to first direction) toward the other side in the longitudinal direction of the developing device 24 (axial direction of rotary shaft 59a) inside the second conveyance path 53. This circulates the developer between the first conveyance path 52 and the second conveyance path 53.

The developer inside the second conveyance path 53 is scooped up to a magnetic force range of the scooping pole S3 by the second conveyance screw 59 disposed below the developing sleeve 5 inside the second conveyance path 53, and is born on the surface of the developing sleeve 5. The developer born on the surface of the developing sleeve 5 is conveyed with rotation of the developing sleeve 5. In the present exemplary embodiment, a rotation speed of the developing sleeve 5 is 475 mm/sec.

A regulation blade 23 (developer regulation member) is disposed as a member forming a thin layer of the developer, with a predetermined gap from the surface of the developing sleeve 5 near the regulating pole N1. The regulation blade 23 is disposed to face the developing sleeve 5 in a non-contact manner. A gap between the developing sleeve 5 and the regulation blade 23 is generally set to about 200 μm to about 500 μm, and an amount of developer born on the developing sleeve 5 is increased as the gap is increased.

The conveyed developer forms a magnetic brush at the regulating pole N1, and a thin layer of a desired amount of developer is formed on the surface of the developing sleeve 5 by the regulation blade 23 that is installed with a predetermined interval from the developing sleeve 5. In the present exemplary embodiment, the gap between the developing sleeve 5 and the regulation blade 23 is set to 280 μm, and a mass per unit area (M/S) of the developer conveyed to a development region R is regulated to 28 mg/cm². Thereafter, the developer conveyed to a portion facing the photosensitive drum 1 forms a magnetic brush again at the developing pole S1, and forms a development nip with the photosensitive drum 1.

As described above, the surface of the photosensitive drum 1 is charged to a constant potential by the charging roller 3, and an image portion is exposed by the exposure device 4 to form an exposure potential. On the other hand, a developing bias is applied to the developing sleeve 5 through a high-voltage circuit. The developing bias is, for example, a bias in which a rectangular alternating-current (AC) waveform is superimposed on a direct-current (DC) waveform of a constant voltage. The toner charged in the developing device 24 receives driving force derived from the potential difference between the developing bias and the potential of the surface of the photosensitive drum 1 and attaches to the image portion inside the development nip (development region R) including a development position where the electrostatic latent image on the surface of the photosensitive drum 1 is developed by the developing sleeve 5. As a result, a developing step is completed. In the present exemplary embodiment, the voltage in which an alternating-current component having a frequency of 10 kHz (kilohertz) and a peak-to-peak voltage Vpp of 1.6 kV (kilovolt) and a direct-current component (Vdc) of −450 V are superimposed is applied from a developing high-voltage power supply (not illustrated); however, the voltage is not limited to the value.

The carriers and the toner not used for development are further conveyed to a downstream in a rotation direction of the developing sleeve 5 by magnetic force at the conveying pole N2. The carriers and the toner not used for development lose magnetic binding force in a zero-gauss area formed between the peeling pole S2 and the scooping pole S3 (region where magnetic flux density in radial direction of developing sleeve 5 is 10 mT (millitesla) or less), and are collected into the second conveyance path 53 again.

When the development operation is performed, only the toner is consumed from the developer. Therefore, the weight ratio of the toner to the developer (T/D ratio) is reduced. Therefore, the T/D ratio is controlled to a predetermined value by performing toner replenishing operation. In the first exemplary embodiment, the predetermined T/D ratio is set to 8%.

The toner is replenished from a toner replenishment port provided in the developing container 2. In the first exemplary embodiment, the toner replenishment port is provided at an upstream end of the first conveyance screw 58 in the first direction above outside of the first conveyance path 52. However, the toner replenishment port may be provided at any of various positions depending on a main body configuration of the image forming apparatus 100 and the like, and is not limited thereto. The replenished toner circulates through the first conveyance path 52 and the second conveyance path 53 while being stirred and conveyed together with the developer by the first conveyance screw 58 and the second conveyance screw 59.

### (Configuration of Drum Cartridge)

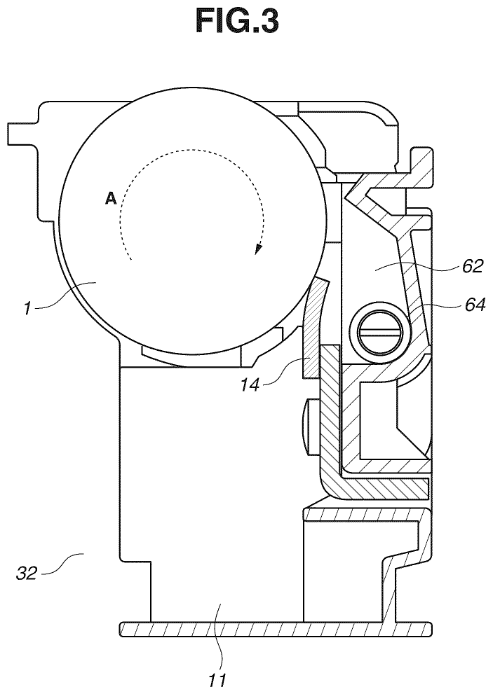

Next, a detailed configuration of the drum cartridge 32 is described with reference to a cross-sectional view in FIG. 3.

The drum cartridge 32 has a configuration in which the photosensitive drum 1, the charging roller (not illustrated), a cleaning roller (not illustrated) as a cleaning member cleaning the surface of the charging roller, and a cleaning blade 14 are integrally held by a drum container 11 as a frame body. The drum cartridge 32 is detachable from the image forming apparatus 100 by being slid from the apparatus main body of the image forming apparatus 100 along a longitudinal direction. Thus, the drum cartridge 32 is replaceable in maintenance and the like.

The photosensitive drum 1 is held by the drum container 11 through bearings so as to be rotatable around a rotation axis. The photosensitive drum 1 is provided with a coupling for receiving driving force from a motor (driving unit) serving as a driving source provided in the apparatus main body of the image forming apparatus 100 to rotate the photosensitive drum 1, in a state of being attached to the image forming apparatus 100.

The drum container 11 includes the cleaning blade 14 that is fixed so as to abut on the surface of the photosensitive drum 1 in a direction counter to the rotation direction of the photosensitive drum 1 during the image forming operation. The cleaning blade 14 functions as a cleaning member for cleaning the surface of the photosensitive drum 1.

The drum cartridge 32 includes, near the cleaning blade 14, a recovery portion 62 for recovering transfer residual toner removed from the surface of the photosensitive drum 1 by the cleaning blade 14. The drum cartridge 32 further includes a toner conveyance screw 64 as a conveyance unit for conveying the toner recovered to the recovery portion 62 to outside of the drum cartridge 32. The toner conveyed to the outside of the drum cartridge 32 by the toner conveyance screw 64 is recovered to a recovered toner container provided in the apparatus main body of the image forming apparatus 100.

At an end of the photosensitive drum 1 in the longitudinal direction, a gear as a rotation member fixed so as to be rotated integrally with the photosensitive drum around the rotation axis of the photosensitive drum 1 is provided. When rotational force of the gear integrally rotated with rotation of the photosensitive drum 1 is transmitted to the toner conveyance screw 64, the toner conveyance screw 64 is rotated, and the transfer residual toner recovered in the recovery portion 62 is conveyed to the outside of the drum cartridge 32.

### (Sheet Member Provided in Developing Device)

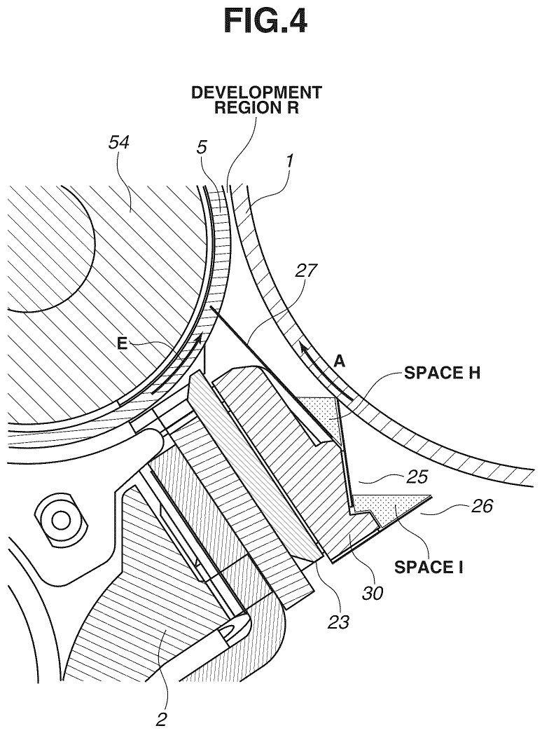

Scattering of the toner from the development region R is described with reference to FIG. 4. FIG. 4 is a cross-sectional view illustrating arrangement of sheet members provided in the developing device 24 according to the first exemplary embodiment.

During the image forming operation, an air flow occurs on the surface of the developing sleeve 5 with rotation of the developing sleeve 5. When a layer thickness of the developer passing through the gap between the developing sleeve 5 and the regulation blade 23 is regulated by the regulation blade 23, the toner held on the surfaces of the carriers by electrostatic force may be liberated from the surfaces of the carriers by the air flow. As a result, in a region on a downstream of a position where the developing sleeve 5 comes closest to the regulation blade 23 and on an upstream of a position where the developing sleeve 5 comes closest to the photosensitive drum 1 in a rotation direction E of the developing sleeve 5, a scattering amount of the toner tends to be increased. The rotation direction E of the developing sleeve 5 is a normal rotation direction that is the rotation direction of the developing sleeve 5 during the image forming operation. The position where the developing sleeve 5 comes closest to the photosensitive drum 1 corresponds to the development position where the electrostatic latent image on the surface of the photosensitive drum 1 is developed by the developing sleeve 5.

Therefore, in the first exemplary embodiment, a first sheet member 25 for suppressing scattering of the toner is bonded to a sheet bonding member 30 attached to the regulation blade 23.

The first sheet member 25 is a sheet member for collecting the scattering toner when the layer thickness of the developer passing through the gap between the developing sleeve 5 and the regulation blade 23 is regulated by the regulation blade 23. The first sheet member 25 has flexibility, and is disposed in contact with the photosensitive drum 1 to face the photosensitive drum 1. In the first exemplary embodiment, as the first sheet member 25, a polyethylene terephthalate (PET) sheet having a thickness of 23 μm is adopted.

As illustrated in FIG. 4, the first sheet member 25 is disposed to seal a region on the upstream of the position (development position) where the developing sleeve 5 comes closest to the photosensitive drum 1 in a rotation direction A (normal rotation direction) of the photosensitive drum 1 during the image forming operation. Further, the first sheet member 25 is provided in contact with the photosensitive drum 1 at a position on the upstream of the development position and on the downstream of the position where the cleaning blade 14 is in contact with the photosensitive drum 1, in the rotation direction A (normal rotation direction) of the photosensitive drum 1.

The other end (fixed end) of the first sheet member 25 is bonded to the sheet bonding member 30 such that a gap with the photosensitive drum 1 is reduced from the upstream to the downstream in the rotation direction A of the photosensitive drum 1. Further, the other end (fixed end) of the first sheet member 25 is bonded to the sheet bonding member 30 such that a free end of the first sheet member 25 on a side opposite to the fixed end comes into contact with the photosensitive drum 1.

The first sheet member 25 is provided to face the developing sleeve 5 over a substantially entire region of the developing sleeve 5 corresponding to a maximum image region of an image region where an image can be formed on the surface of the photosensitive drum 1, in the rotation axis direction of the developing sleeve 5.

As illustrated in FIG. 4, a third sheet member 27 disposed in contact with the developing sleeve 5 is provided at a position on the downstream of the position where the regulation blade 23 comes closest to the developing sleeve 5 and on the upstream of the development position in the rotation direction E of the developing sleeve 5. The third sheet member 27 collects the toner because the toner tends to easily scatter when the developer passes through the gap between the regulation blade 23 and the developing sleeve 5. As illustrated in FIG. 4, the third sheet member 27 is bonded to the sheet bonding member 30 as with the first sheet member 25.

In the first exemplary embodiment, as the third sheet member 27, a urethane sheet having a thickness of 100 μm is adopted. As described above, in the first exemplary embodiment, as the first sheet member 25, the PET sheet having the thickness of 23 μm is adopted. In other words, the first sheet member 25 abutting on the photosensitive drum 1 has the thickness less than the thickness of the third sheet member 27 abutting on the developing sleeve 5. Therefore, contact pressure when the first sheet member 25 comes into contact with the photosensitive drum 1 is set to be less than contact pressure when the third sheet member 27 comes into contact with the developing sleeve 5.

### (Cleaning Mode)

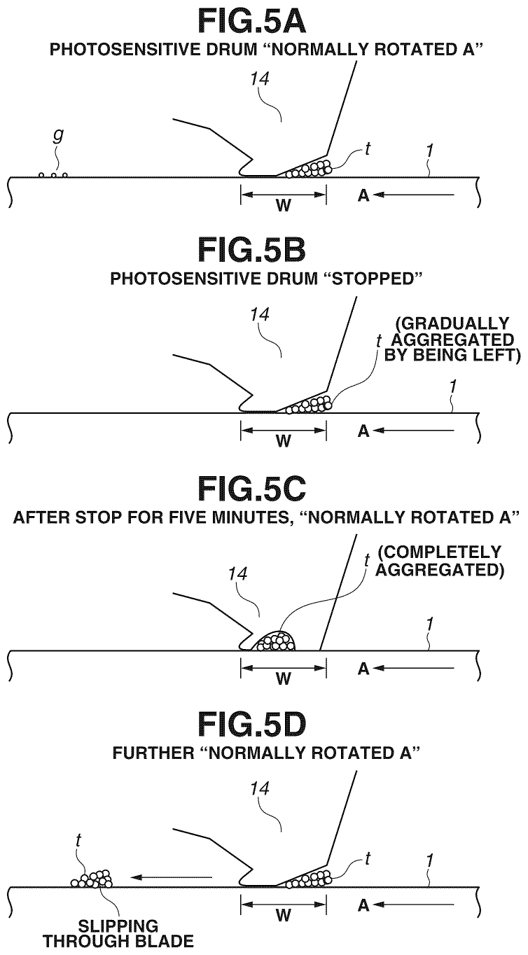

FIGS. 5A to 5D are enlarged schematic diagrams illustrating a front-side edge of the cleaning blade 14 when the photosensitive drum 1 is normally rotated. A time series is illustrated in order of FIGS. 5A, 5B, 5C, and 5D. In FIGS. 5A to 5D, the photosensitive drum 1, the cleaning blade 14, and an abutting portion W of the cleaning blade 14 and the photosensitive drum 1 are illustrated.

FIG. 5A illustrates a state where the cleaning blade 14 abuts on the photosensitive drum 1 during execution of the image forming operation, and the photosensitive drum 1 is normally rotated and driven in a direction of an arrow A. The cleaning blade 14 is disposed such that the front-side edge of the cleaning blade 14 abuts on the photosensitive drum 1 with predetermined pressing force.

The front-side edge of the cleaning blade 14 abuts on the photosensitive drum 1 in a direction counter to the normal rotation direction of the photosensitive drum 1 with abutting pressure to the photosensitive drum 1. Therefore, the front-side edge of the cleaning blade 14 comes into tight contact with the photosensitive drum 1 while being distorted due to dragging by the photosensitive drum 1. The surface of the photosensitive drum 1 is wiped by the front-side edge of the cleaning blade 14 abutting on the photosensitive drum 1, and the transfer residual toner is scraped off from the photosensitive drum 1.

On the other hand, at a part on the photosensitive drum 1 short of the front-side edge of the cleaning blade 14, toner t is dammed by the cleaning blade 14 and is accumulated (see FIG. 5A).

When rotation of the photosensitive drum 1 is stopped while the toner t is accumulated, the toner t is aggregated and fixed to the surface of the photosensitive drum 1 (see FIG. 5B and FIG. 5C). As a result, at start of next normal rotation of the photosensitive drum 1, the toner t may slip through the front-side edge of the cleaning blade 14 (see FIG. 5D).

Therefore, in the first exemplary embodiment, a mode (hereinafter, referred to as cleaning mode) in which the photosensitive drum 1 is rotated and driven in a direction (direction of arrow B) opposite to the normal rotation direction (direction of arrow A) is performed. This prevents the toner t from being aggregated at the abutting portion of the cleaning blade 14 and the photosensitive drum 1.

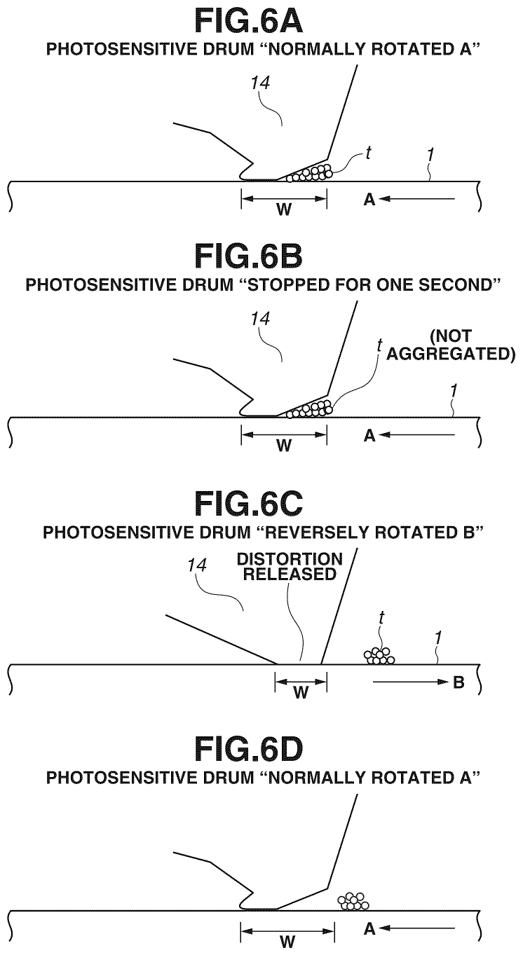

FIGS. 6A to 6D are enlarged schematic diagrams illustrating the front-side edge of the cleaning blade 14 when the photosensitive drum 1 is reversely rotated. A time series is illustrated in order of FIGS. 6A, 6B, 6C, and 6D. As illustrated in FIG. 6C, the photosensitive drum 1 is rotated in a direction B opposite to the normal rotation direction A during the image forming operation. As a result, the toner t accumulated at the part on the photosensitive drum 1 short of the front-side edge of the cleaning blade 14 is removed from the front-side edge of the cleaning blade 14 before the toner t is aggregated. Thereafter, the photosensitive drum 1 is stopped.

Further, as illustrated in FIG. 6D, the photosensitive drum 1 is rotated again in the normal rotation direction A during the image forming operation. At this time, a drive distance of the photosensitive drum 1 rotated in the normal rotation direction A is shorter than a drive distance of the photosensitive drum 1 rotated in the reverse rotation direction B. As a result, the cleaning blade 14 is stopped in the abutting state same as in the image forming operation, and accumulation of the toner t is stopped on the upstream of the abutting portion of the cleaning blade 14 in the normal rotation direction A. In a case where the cleaning blade 14 is left in a state where distortion is released as illustrated in FIG. 6C, the front-side edge of the cleaning blade 14 is not distorted unlike the state illustrated in FIG. 6A when the photosensitive drum 1 is rotated in the normal rotation direction A in next image forming operation. In a case where the front-side edge of the cleaning blade 14 is distorted as illustrated in FIG. 6A, slipping of the toner t or squeaking of the cleaning blade 14 may occur. Therefore, at the end of the image forming operation, the photosensitive drum 1 is stopped in a state of being driven in the normal rotation direction A.

The transfer residual toner on the photosensitive drum 1 is scraped off by the cleaning blade 14, but the external additive externally added to the toner in the developer may slip through the cleaning blade 14 because the external additive is finer than the toner t.

An external additive g in the toner t is described in detail. The developer used in the present exemplary embodiment is a dry two-component developer containing the carriers and the toner t to which fine particles (external additive g) of negative polarity that is the same polarity as the charging polarity of the toner t are added. In the present exemplary embodiment, to suitably control the powder flowability and the charging property of the toner, the external additive g contains at least titanium oxide and amorphous silica (silica).

In a developing step of developing the electrostatic latent image formed on the photosensitive drum 1 by using the developer, the toner t of the developer born on the developing sleeve 5 is mainly used for development of the image portion (light potential portion of electrostatic latent image). At this time, the external additive g added to the toner t and having the negative polarity that is the same polarity as the charging polarity of the toner t is also simultaneously used for development. A part of the external additive added to the toner is reduced in adhesive force with the toner t by being stirred inside the developing container 2, and the external additive is partially separated from the toner t.

The toner t and the external additive g on the photosensitive drum 1 are primarily transferred onto the intermediate transfer belt 8 in the transfer step, but part of the toner t and the external additive g having a small particle diameter and large non-electrostatic adhesive force remain on the photosensitive drum 1 without being transferred.

Thereafter, out of the transfer residual toner and the external additive having reached a cleaning step, the transfer residual toner is cleaned by the cleaning blade 14, but the external additive g remains on the photosensitive drum 1 without being cleaned completely because of the small particle diameter and large adhesive force with the photosensitive drum 1. As a result, the external additive g having slipped through the cleaning blade 14 is rotated with the photosensitive drum 1 in a state of adhering to the surface of the photosensitive drum 1, passes through the abutting portion where the charging roller abuts on the photosensitive drum 1, and reaches the development nip formed between the developing sleeve 5 and the photosensitive drum 1.

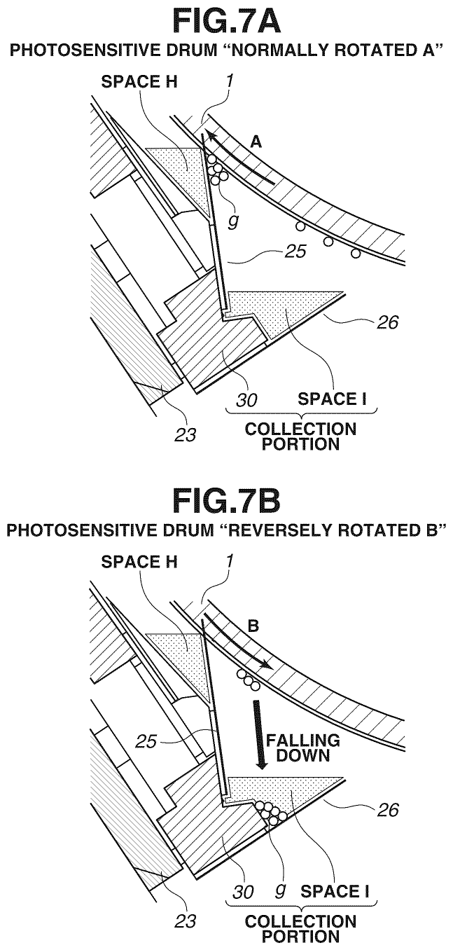

Behavior of the external additive g on the first sheet member 25 when the photosensitive drum 1 is reversely rotated is described with reference to outline diagrams in FIGS. 7A and 7B. A time series is illustrated in order of FIGS. 7A and 7B.

The external additive g having slipped through the cleaning blade 14 is rotated with the photosensitive drum 1 in the state of adhering to the surface of the photosensitive drum 1. At this time, since the first sheet member 25 abuts on the photosensitive drum 1, the external additive g adhering to the surface of the photosensitive drum 1 may adhere to the surface of the first sheet member 25. When the photosensitive drum 1 is rotated in the reverse rotation direction B in the state where the external additive g adheres to the surface of the first sheet member 25, the external additive g may fall down in a gravity direction, and scatter on the optical axis of the exposure device 4.

Therefore, in the first exemplary embodiment, in addition to the first sheet member 25 in contact with the photosensitive drum 1, a second sheet member 26 (collection sheet) facing the photosensitive drum 1 in a non-contact manner is provided.

The second sheet member 26 is disposed at a position on the downstream of the exposure position where the surface of the photosensitive drum 1 is exposed by the exposure device 4 and on the upstream of the position where the first sheet member 25 abuts on the surface of the photosensitive drum 1 in the normal rotation direction A of the photosensitive drum 1.

As illustrated in FIG. 7B, the external additive g falling down in the gravity direction and scattering when the photosensitive drum 1 is rotated in the reverse rotation direction B is collected in a space (hereinafter, referred to as space I) surrounded by the first sheet member 25, the second sheet member 26, and the sheet bonding member 30. In other words, the first sheet member 25, the second sheet member 26, and the sheet bonding member 30 form a collection portion for collecting the external additive g falling down in the gravity direction and scattering when the photosensitive drum 1 is rotated in the reverse rotation direction B. In the present exemplary embodiment, an example in which the collection portion is configured by three members, namely, the first sheet member 25, the second sheet member 26, and the sheet bonding member 30 is illustrated; however, the collection portion is not limited thereto. As modifications, the collection portion may be configured by one member, namely, the second sheet member 26 or the sheet bonding member 30, or may be configured by two members, namely, the second sheet member 26 and the sheet bonding member 30.

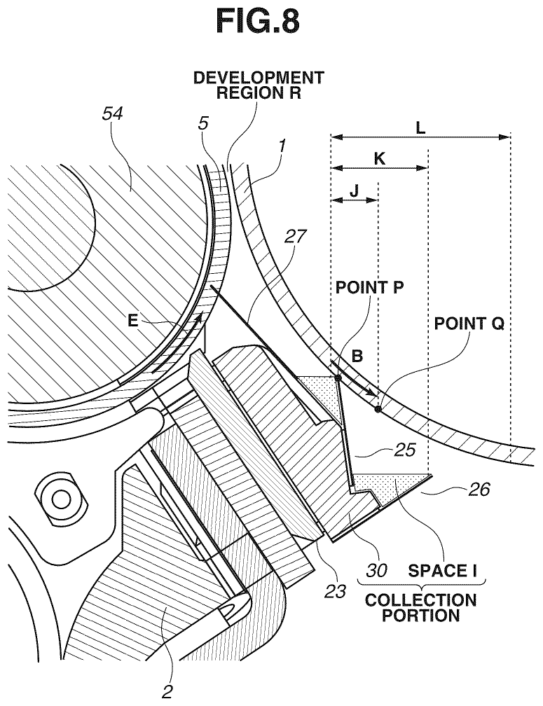

A leading edge position of each of the first sheet member 25 and the second sheet member 26 provided in the developing device 24 according to the first exemplary embodiment is described with reference to an outline diagram in FIG. 8.

As illustrated in FIG. 8, the second sheet member 26 is bonded to the sheet bonding member 30 as with the first sheet member 25. A position of a free end (position where second sheet member 26 comes closest to photosensitive drum 1) on a side opposite to a fixed end of the second sheet member 26 fixed to the sheet bonding member 30 is defined as a position K. As illustrated in FIG. 8, a position where the photosensitive drum 1 is stopped after reversely rotated from a position (point P) where the leading edge of the first sheet member 25 abuts on the photosensitive drum 1 as a starting point in the cleaning mode (arrival position of photosensitive drum 1 when reversely rotated and driven) is defined as a position J (point Q). As illustrated in FIG. 8, an exposure position where the surface of the photosensitive drum 1 is exposed by the exposure device 4 is defined as a position L.

As illustrated in FIG. 8, the position K is positioned on the upstream of the position J and on the downstream of the position L in the normal rotation direction A of the photosensitive drum 1. In other words, the position K is positioned on the downstream of the position J and on the upstream of the position L in the reverse rotation direction B of the photosensitive drum 1.

In the first exemplary embodiment, when the photosensitive drum 1 is stopped after reversely rotated from the position where the leading edge of the first sheet member 25 abuts on the photosensitive drum 1 in the cleaning mode, the photosensitive drum 1 is stopped at a position before the exposure position (position L).

As illustrated in FIG. 8, the collection portion is provided to face the photosensitive drum 1 in a non-contact manner in a region below the point P in the gravity direction and between the point P and the point Q (position J) in a horizontal direction.

One end (fixed end) of the second sheet member 26 in a longitudinal direction is bonded to the sheet bonding member 30, and the other end (free end on side opposite to fixed end) of the second sheet member 26 in the longitudinal direction is disposed in a non-contact manner with the photosensitive drum 1. At this time, the fixed end of the second sheet member 26 is positioned below the free end of the second sheet member 26 in the gravity direction.

The free end of the second sheet member 26 is positioned between the position J (point Q) and the exposure position (position L) in the horizontal direction. More specifically, the free end of the second sheet member 26 is positioned above an irradiation unit of the exposure device 4 in the gravity direction, and between the position J (point Q) and the irradiation unit of the exposure device 4 in the horizontal direction. Therefore, when the photosensitive drum 1 is rotated in the reverse rotation direction B in the state where the external additive g adheres to the surface of the first sheet member 25, it is possible to prevent the external additive g from falling down in the gravity direction and scattering on the optical path of the exposure device 4.

The second sheet member 26 is provided to face the photosensitive drum 1 over a substantially entire region of the photosensitive drum 1 corresponding to the maximum image region of the image region where an image can be formed on the surface of the photosensitive drum 1, in the rotation axis direction of the developing sleeve 5.

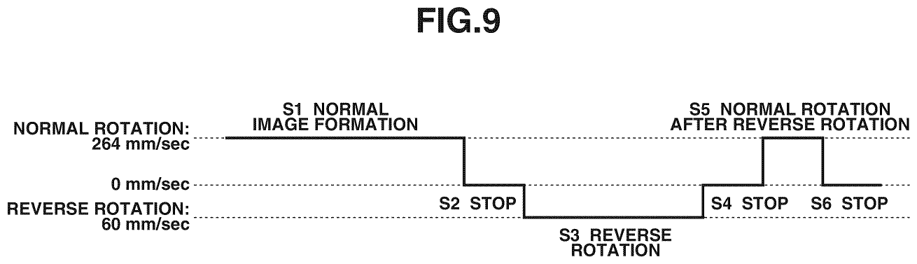

Detailed operation of the cleaning mode in the first exemplary embodiment is described with reference to FIG. 9 and Table 1. FIG. 9 is a diagram illustrating a sequence relating to driving and stopping of the photosensitive drum 1 in the cleaning mode. Table 1 illustrates a relationship between a speed of the photosensitive drum 1 and the drive distance of the photosensitive drum 1 when the sequence relating to driving and stopping of the photosensitive drum 1 in the cleaning mode is performed.

After completion of normal image formation (S1) at the speed of 264 mm/sec, driving of the photosensitive drum 1 is stopped, and a state is put into a state where the photosensitive drum 1 can be reversely rotated (S2). Thereafter, the photosensitive drum 1 is reversely rotated and driven for a first predetermined time (time described in Table 1) at the speed of 60 mm/sec to remove accumulation of the toner t from the front-side edge of the cleaning blade 14 (S3). After the photosensitive drum 1 is driven in the reverse rotation direction for the first predetermined time (time described in Table 1), the photosensitive drum 1 is stopped again, and the state is put into a state where the photosensitive drum 1 can be normally rotated (S4). After the photosensitive drum 1 is normally rotated and driven for a second predetermined time (time described in Table 1) at the speed of 264 mm/sec (S5), driving of the photosensitive drum 1 is stopped (S6), and the sequence is ended.

TABLE 1

| | | During | During Normal |
|---|---|---|---|
| | During Normal | Reverse | Rotation After |
| | Image Formation | Rotation | Reverse Rotation |
| Photosensitive Drum | 264 | 60 | 264 |
| Circumferential Speed | | | |
| [mm/sec] | | | |
| Time [sec] | — | 0.180 | 0.070 |
| Actual Moving | — | 3.0 to 4.5 | 0.3 to 2.9 |
| Distance [mm] | | | |

During the reverse rotation of the photosensitive drum 1, the photosensitive drum 1 is driven at a speed lower than the speed during the normal image formation in order to stabilize the drive distance of the photosensitive drum 1 and facilitate stopping at a desired position. The relationship between the drive time of the photosensitive drum 1 and the moving distance of the photosensitive drum 1 during the sequence is as described in Table 1. The drive distance of the photosensitive drum 1 depends on a configuration of a driving device (not illustrated) and a configuration of the image forming unit U, and also depends on a delay time from input of a driving start signal to the driving device until actual rotation start of the photosensitive drum 1, and a delay time from input of a driving stop signal until actual rotation stop of the photosensitive drum 1.

In the first exemplary embodiment, the example is described in which the sheet bonding member 30 and the regulation blade 23 are separately provided, and the first sheet member 25, the second sheet member 26, and the third sheet member 27 are boned to the sheet bonding member 30 attached to the regulation blade 23. The configuration is not limited thereto, and the sheet bonding member 30 and the regulation blade 23 may be integrally provided as a modification.

The image forming apparatus 100 according to the first exemplary embodiment described above includes the photosensitive drum 1, the cleaning blade 14 coming into contact with the photosensitive drum 1 to clean the photosensitive drum 1, and the exposure device 4. The image forming apparatus 100 further includes the developing device 24 that includes the developing sleeve 5, the developing container 2 housing the developer, the first sheet member 25 provided in contact with the photosensitive drum 1, and the second sheet member 26 provided in a non-contact manner with the photosensitive drum 1. The image forming apparatus 100 can perform the mode (cleaning mode) in which the photosensitive drum 1 is rotated in a second rotation direction opposite to the rotation direction (first rotation direction) of the photosensitive drum 1 during execution of the image forming operation. The position (position K) where the second sheet member 26 comes closest to the photosensitive drum 1 is on the upstream in the first rotation direction, of the position (position K) where the photosensitive drum 1 is stopped after rotated in the second rotation direction from the position where the first sheet member 25 is in contact with the photosensitive drum 1 in the cleaning mode.

According to such a first exemplary embodiment, when the photosensitive drum 1 is reversely rotated, it is possible to prevent the external additive g interposed between the first sheet member 25 provided in the developing device 24 and the photosensitive drum 1 from blocking the optical path of the exposure device 4.

In the above-described first exemplary embodiment, the example is described in which, in the cleaning mode, after the photosensitive drum 1 is reversely rotated and driven, the photosensitive drum 1 is normally rotated and driven, and then stopped. In a second exemplary embodiment, an example is described in which, in the cleaning mode, after a set of reversely rotating and driving the photosensitive drum 1 and then normally rotating and driving the photosensitive drum 1 is performed a plurality of times, the photosensitive drum 1 is stopped.

In an example illustrated in Table 2, in the cleaning mode, after the set of reversely rotating and driving the photosensitive drum 1 and then normally rotating and driving the photosensitive drum 1 is performed three times, the photosensitive drum 1 is stopped.

TABLE 2

| | | First | | Second | | Third | |
|---|---|---|---|---|---|---|---|
| | | | During | | During | | During |
| | | | Normal | | Normal | | Normal |
| | During | | Rotation | | Rotation | | Rotation |
| | Normal | During | After | During | After | During | After |
| | Image | Reverse | Reverse | Reverse | Reverse | Reverse | Reverse |
| | Formation | Rotation | Rotation | Rotation | Rotation | Rotation | Rotation |
| Photosensitive | 264 | 60 | 264 | 60 | 264 | 60 | 264 |
| Drum | | | | | | | |
| Circumferential | | | | | | | |
| Speed | | | | | | | |
| [mm/sec] | | | | | | | |
| Time [sec] | — | 0.18 | 0.27 | 0.18 | 0.41 | 0.18 | 0.07 |
| Actual | — | 3.0 to 4.5 | About 106 | 3.0 to 4.5 | About 268 | 3.0 to 4.5 | 0.3 to 2.9 |
| Moving | | | | | | | |
| Distance | | | | | | | |
| [mm] | | | | | | | |

In the state where the photosensitive drum 1 abuts on the intermediate transfer belt 8, when the intermediate transfer belt 8 is rotated and driven in order to remove paper dust clogging between the intermediate transfer belt 8 and an abutment part of the intermediate transfer belt cleaning blade 60, the photosensitive drum 1 is also rotated and driven in conjunction therewith. At this time, during the reverse rotational driving, when the photosensitive drum 1 is stopped after reversely rotated from the position (point P) where the leading edge of the first sheet member 25 abuts on the photosensitive drum 1 in the cleaning mode, the photosensitive drum 1 is stopped at the position J (point Q) before the position K. Further, during the reverse rotational driving and the normal rotational driving in a final set in the case where the set of reversely rotating and driving the photosensitive drum 1 and then normally rotating and driving the photosensitive drum 1 is performed a plurality of times, the moving distance of the photosensitive drum 1 by the normal rotational driving is made shorter than the moving distance of the photosensitive drum 1 by the reverse rotational driving.

In the example illustrated in Table 2, during the reverse rotational driving and the normal rotational driving in the third set that is the final set, the moving distance of the photosensitive drum 1 by the reverse rotational driving is set to 3.0 mm to 4.5 mm, whereas the actual moving distance of the photosensitive drum 1 by the normal rotational driving is set to 0.3 mm to 2.9 mm. This makes it possible to stop the cleaning blade 14 in the abutting state same as in the image forming operation, and to stop accumulation of the toner t at a position on the upstream of the abutting portion of the cleaning blade 14 in the normal rotation direction A.

As in a modification illustrated in Table 3, when the set of reversely rotating and driving the photosensitive drum 1 and then normally rotating and driving the photosensitive drum 1 is performed a plurality of times, the moving distance of the photosensitive drum 1 by the reverse rotational driving may be varied for each set.

TABLE 3

| | | First | | Second | | Third | |
|---|---|---|---|---|---|---|---|
| | | | During | | During | | During |
| | | | Normal | | Normal | | Normal |
| | During | | Rotation | | Rotation | | Rotation |
| | Normal | During | After | During | After | During | After |
| | Image | Reverse | Reverse | Reverse | Reverse | Reverse | Reverse |
| | Formation | Rotation | Rotation | Rotation | Rotation | Rotation | Rotation |
| Photosensitive | 264 | 60 | 264 | 60 | 264 | 60 | 264 |
| Drum | | | | | | | |
| Circumferential | | | | | | | |
| Speed | | | | | | | |
| [mm/sec] | | | | | | | |
| Time [sec] | — | 0.14 | 0.27 | 0.09 | 0.41 | 0.18 | 0.07 |
| Actual | — | 1.7 to 3.2 | About 106 | 0.5 to 2.0 | About 268 | 3.0 to 4.5 | 0.3 to 2.9 |
| Moving | | | | | | | |
| Distance | | | | | | | |
| [mm] | | | | | | | |

In the modification illustrated in Table 3, among the sets of reversely rotating and driving the photosensitive drum 1 and then normally rotating and driving the photosensitive drum 1, the moving distance of the photosensitive drum 1 by the reverse rotational driving in the third set is the largest (when photosensitive drum 1 is reversely rotated and driven from point P as starting point, photosensitive drum 1 reaches most downstream position in reverse rotational direction B of photosensitive drum 1). In such a case, a stop position of the photosensitive drum 1 during the reverse rotational driving in which the moving distance of the photosensitive drum 1 by the reverse rotational driving is the largest (arrival position on most downstream of point P in reverse rotation direction B of photosensitive drum 1 when photosensitive drum 1 is reversely rotated and driven from point P as starting point) is used as a reference. In other words, in the cleaning mode, during the reverse rotational driving in the third set, when the photosensitive drum is stopped after reversely rotated from the position (point P) where the leading edge of the first sheet member 25 abuts on the photosensitive drum 1, the photosensitive drum 1 is stopped at the position J (point Q) before the position K. This makes it possible to perform the cleaning mode without causing the external additive g to reach the exposure position L.

### Other Exemplary Embodiments

The present disclosure is not limited to the above-described exemplary embodiments. Various modifications (including organic combination of exemplary embodiments) can be made based on the spirit of the present disclosure, and are not excluded from the scope of the present disclosure.

In the above-described exemplary embodiments, as illustrated in FIG. 1, the image forming apparatus 100 primarily transfers the toner image born on each of the photosensitive drums 1 (1Y, 1M, 1C, and 1K) to the intermediate transfer belt 8. Thereafter, the image forming apparatus 100 secondarily transfers the toner images born on the intermediate transfer belt 8 to the sheet S by bringing the sheet S into contact with the intermediate transfer belt 8. In the above-described exemplary embodiments, the image forming apparatus 100 having such a configuration is described as an example; however, the configuration is not limited thereto. The exemplary embodiments can be applied to an image forming apparatus that directly transfers the toner image born on each of the photosensitive drums 1 (1Y, 1M, 1C, and 1K) to the sheet S by bringing the sheet S into direct contact with each of the photosensitive drums 1 (1Y, 1M, 1C, and 1K).

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2023-205722, filed Dec. 5, 2023, and No. 2024-165239, filed Sep. 24, 2024, which are hereby incorporated by reference herein in their entirety.

What is claimed is:

1. An image forming apparatus, comprising:
a rotatable photosensitive body;
an exposure device configured to expose the photosensitive body to form an electrostatic latent image on the photosensitive body;
a developing device including a developing container configured to house a developer containing toner and carriers, and a developer bearing member configured to bear and convey the developer to a development position where the electrostatic latent image formed on the photosensitive body by the exposure device is developed;
a cleaning member provided in contact with the photosensitive body and configured to clean the photosensitive body;
a driving unit configured to rotate and drive the photosensitive body in a first rotation direction during development operation in which the developing device develops the electrostatic latent image formed on the photosensitive body;
a control unit configured to perform a mode for controlling the driving unit to rotate and drive the photosensitive body in a second rotation direction opposite to the first rotation direction, during non-development operation in which the development operation is not performed;
a sheet provided in contact with the photosensitive body at a position on a downstream of a position where the cleaning member is in contact with the photosensitive body and on an upstream of the development position in the first rotation direction; and
a collection portion provided to face the photosensitive body in a non-contact manner in a region below a contact position where the sheet is in contact with the photosensitive body in a gravity direction and between the contact position and an arrival position when the photosensitive body is rotated and driven in the second rotation direction with the contact position as a starting point in the mode in a horizontal direction.

2. The image forming apparatus according to claim 1, further comprising a collection sheet provided to face the photosensitive body in a non-contact manner at a position on a downstream of an exposure position where the photosensitive body is exposed by the exposure device and on an upstream of the contact position in the first rotation direction,
wherein the collection portion includes the collection sheet,
wherein a free end of the collection sheet is positioned above a fixed end of the collection sheet in the gravity direction, and
wherein the free end of the collection sheet is positioned between the exposure position and the arrival position when the photosensitive body is rotated and driven in the second rotation direction with the contact position as the starting point in the mode in the horizontal direction.

3. The image forming apparatus according to claim 2,
wherein the exposure device includes a light emitting element configured to emit light, and an irradiation unit configured to perform irradiation with the light emitted from the light emitting element,
wherein the free end of the collection sheet is positioned above the irradiation unit in the gravity direction, and
wherein the free end of the collection sheet is positioned between the irradiation unit and the arrival position when the photosensitive body is rotated and driven in the second rotation direction with the contact position as the starting point in the mode in the horizontal direction.

4. The image forming apparatus according to claim 2,
wherein the developing device further includes a sheet bonding member to which the collection sheet is bonded, and
wherein the collection portion includes the collection sheet and the sheet bonding member.

5. The image forming apparatus according to claim 4,
wherein the developing device further includes a regulation member configured to regulate an amount of developer born on the developer bearing member, and
wherein the sheet bonding member is formed integrally with the regulation member.

6. The image forming apparatus according to claim 2,
wherein the developing device further includes a sheet bonding member to which the sheet and the collection sheet are bonded, and
wherein the collection portion includes the sheet, the collection sheet, and the sheet bonding member.

7. The image forming apparatus according to claim 6,
wherein the developing device further includes a regulation member configured to regulate an amount of developer born on the developer bearing member, and
wherein the sheet bonding member is formed integrally with the regulation member.

8. The image forming apparatus according to claim 1, wherein the collection portion is provided over a substantially entire region of a maximum image region where an image is formable on the photosensitive body, in a rotation axis direction of the photosensitive body.

9. The image forming apparatus according to claim 1,
wherein the developer bearing member is rotatable, and
wherein the developing device further includes a regulation member configured to regulate an amount of developer born on the developer bearing member, and another sheet provided in contact with the developer bearing member at a position on a downstream of a position where the regulation member comes closest to the developer bearing member and on an upstream of the development position in a rotation direction of the developer bearing member.

10. The image forming apparatus according to claim 1, wherein, in the mode, the control unit controls the driving unit to rotate and drive the photosensitive body by a first moving distance in the second rotation direction, and then to rotate and drive the photosensitive body by a second moving distance shorter than the first moving distance in the first rotation direction.

11. An image forming apparatus, comprising:
a rotatable photosensitive body;
an exposure device configured to expose the photosensitive body to form an electrostatic latent image on the photosensitive body;
a developing device including a developing container configured to house a developer containing toner and carriers, and a developer bearing member configured to bear and convey the developer to a development position where the electrostatic latent image formed on the photosensitive body by the exposure device is developed;
a cleaning member provided in contact with the photosensitive body and configured to clean the photosensitive body;
a driving unit configured to rotate and drive the photosensitive body in a first rotation direction during development operation in which the developing device develops the electrostatic latent image formed on the photosensitive body;
a control unit configured to perform a mode for controlling the driving unit to perform a set of rotating and driving the photosensitive body in a second rotation direction opposite to the first rotation direction and then rotating and driving the photosensitive body in the first rotation direction a plurality of times during non-development operation in which the development operation is not performed;
a sheet provided in contact with the photosensitive body at a position on a downstream of a position where the cleaning member is in contact with the photosensitive body and on an upstream of the development position in the first rotation direction; and
a collection portion provided to face the photosensitive body in a non-contact manner in a region below a contact position where the sheet is in contact with the photosensitive body in a gravity direction and between the contact position and an arrival position on most downstream of the contact position in the second rotation direction when the photosensitive body is rotated and driven in the second rotation direction with the contact position as a starting point in the mode in a horizontal direction.

12. The image forming apparatus according to claim 11, further comprising a collection sheet provided to face the photosensitive body in a non-contact manner at a position on a downstream of an exposure position where the photosensitive body is exposed by the exposure device and on an upstream of the contact position in the first rotation direction,
wherein the collection portion includes the collection sheet,
wherein a free end of the collection sheet is positioned above a fixed end of the collection sheet in the gravity direction, and
wherein the free end of the collection sheet is positioned between the exposure position and the arrival position on the most downstream of the contact position in the second rotation direction when the photosensitive body is rotated and driven in the second rotation direction with the contact position as the starting point in the mode in the horizontal direction.

13. The image forming apparatus according to claim 12,
wherein the exposure device includes a light emitting element configured to emit light, and an irradiation unit configured to perform irradiation with the light emitted from the light emitting element,
wherein the free end of the collection sheet is positioned above the irradiation unit in the gravity direction, and
wherein the free end of the collection sheet is positioned between the irradiation unit and the arrival position on the most downstream of the contact position in the second rotation direction when the photosensitive body is rotated and driven in the second rotation direction with the contact position as the starting point in the mode in the horizontal direction.

14. The image forming apparatus according to claim 12,
wherein the developing device further includes a sheet bonding member to which the collection sheet is bonded, and
wherein the collection portion includes the collection sheet and the sheet bonding member.

15. The image forming apparatus according to claim 14,
wherein the developing device further includes a regulation member configured to regulate an amount of developer born on the developer bearing member, and
wherein the sheet bonding member is formed integrally with the regulation member.

16. The image forming apparatus according to claim 12,
wherein the developing device further includes a sheet bonding member to which the sheet and the collection sheet are bonded, and
wherein the collection portion includes the sheet, the collection sheet, and the sheet bonding member.

17. The image forming apparatus according to claim 16,
wherein the developing device further includes a regulation member configured to regulate an amount of developer born on the developer bearing member, and
wherein the sheet bonding member is formed integrally with the regulation member.

18. The image forming apparatus according to claim 11, wherein the collection portion is provided over a substantially entire region of a maximum image region where an image is formable on the photosensitive body, in a rotation axis direction of the photosensitive body.

19. The image forming apparatus according to claim 11,
wherein the developer bearing member is rotatable, and
wherein the developing device further includes a regulation member configured to regulate an amount of developer born on the developer bearing member, and another sheet provided in contact with the developer bearing member at a position on a downstream of a position where the regulation member comes closest to the developer bearing member and on an upstream of the development position in a rotation direction of the developer bearing member.

20. The image forming apparatus according to claim 11, wherein, in a final set of the plurality of sets in the mode, the control unit controls the driving unit to rotate and drive the photosensitive body by a first moving distance in the second rotation direction, and then to rotate and drive the photosensitive body by a second moving distance shorter than the first moving distance in the first rotation direction.
